(19) United States
(12) Patent Application Publication
(10) Pub. No.: US 2014/0352489 A1
(43) Pub. Date: Dec. 4, 2014

(54) INNER RACE FOR ROCKER ARM ASSEMBLY

(71) Applicant: Electro-Motive Diesel Inc., La Grange, IL (US)

(72) Inventor: Laura Elise Rasmussen, Brookfield, IL (US)

(73) Assignee: Electro-Motive Diesel Inc., La Grange, IL (US)

(21) Appl. No.: 14/461,735

(22) Filed: Aug. 18, 2014

(51) Int. Cl. F16H 25/08

(52) U.S. Cl. CPC F16H 25/08
USPC 74/569

(57) ABSTRACT

A roller assembly for application to a roller rocker arm is disclosed. The roller assembly includes a pin mountable to the roller rocker arm. The pin consists of a carbon steel. An inner race assembly operably connectable to the pin is provided, which includes an inner race member and an outer race member. The inner race member includes carbon steel and the outer race member includes a bronze material. The outer race member is fused to the inner race member, defining a contiguous and unitary inner race assembly. Moreover, a roller member is structured and arranged to be in rotatable engagement with the inner race assembly.

### TECHNICAL FIELD

The present disclosure relates generally to rocker arm assemblies. More specifically, the present disclosure relates to a rocker arm assembly having an inner race made from multi-property materials.

### BACKGROUND

Rocker arm assemblies applied in internal combustion engines are generally configured to actuate valves and/or injectors in a predetermined, known fashion. Such assemblies have a roller supported by a pin, where the pin is fixedly mounted to an associated rocker arm. Typically, an assembly of the pin and the roller incorporates an inner race and a bushing. The bushing is generally press-fitted into the roller, while the inner race is fixedly mounted to the pin. A resultant rocker arm assembly includes a roller-bushing assembly rotatably supported about the inner race-pin assembly.

These bushings are subjected to considerably heavy loads during operation. Owing to a relatively small size of the bushing, in general, such conditions may lead to frequent component deformation and even component fracture. Most failures are irreparable, which necessitate replacement and incurs an extra cost. Occasional temperature extremes further aggravate the situation. Given the challenges to establish a reliable bushing design, currently applied bushings within the rocker arm assemblies are relatively tedious to manufacture. This is an ongoing issue, which makes it considerably difficult to find quality suppliers. Accordingly, research is constantly performed to effectively upgrade and improve the operational characteristics of the rocker arm assemblies.

US Patent Publication 2009/0038572 discloses a cam actuated roller assembly. More particularly, the cam actuated roller assembly includes a roller pin with a core of a first metallic material surrounded by a cladding of a second metallic material. Although this reference discusses an apparent solution involving a cladding of a different material disposed about the pin, no solution suggests an alternative arrangement provided to the inner race.

### SUMMARY OF THE INVENTION

Various aspects of the present disclosure illustrate a roller assembly that applies to a roller rocker arm. The roller assembly includes a pin mountable to the roller rocker arm. The pin includes of carbon steel. Further, an inner race assembly, operably connectable to the pin, includes an inner race member and an outer race member. The inner race member includes carbon steel while the outer race member includes a bronze material. Moreover, the outer race member is fused to the inner race member to define a contiguous and unitary inner race assembly. Furthermore, a roller member is structured and arranged to be in rotatable engagement with the inner race assembly.

### BRIEF DESCRIPTION OF THE DRAWINGS

FIG. 1 is an exploded view of an exemplary roller assembly, in accordance with the concepts of the present disclosure;

FIG. 2 is an exemplary side view of the components applied for the roller assembly of FIG. 1, in accordance to the concepts of the present disclosure; and

FIG. 3 is a partial cross-sectional view of the roller assembly of FIG. 1 depicted as an assembled unit, in accordance with the concepts of the present disclosure.

### DETAILED DESCRIPTION

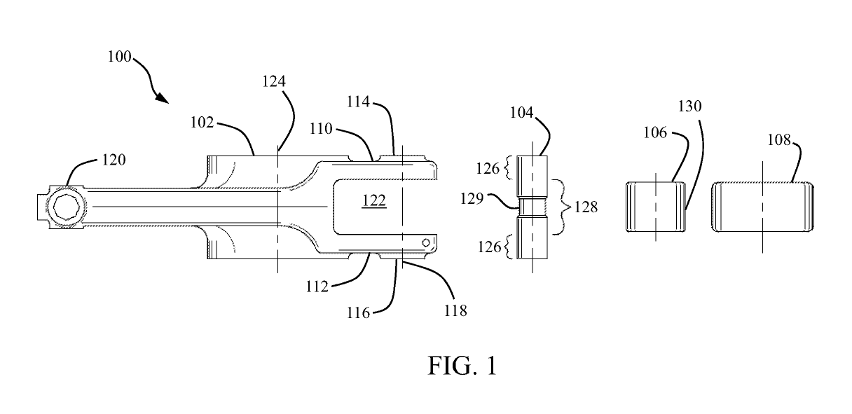

Referring to FIG. 1, there is shown an exploded view of an exemplary roller assembly 100. The roller assembly 100 includes a roller rocker arm 102, a pin 104 mounted to the roller rocker arm 102, an inner race assembly 106 mounted to the pin 104, and a roller member 108, structured and arranged to be in rotatable engagement with the inner race assembly 106.

The roller rocker arm 102 may be one of the widely known rocker arm units available. The roller rocker arm 102 may include a pair of arms, namely a first arm 110 and a second arm 112. Both the first arm 110 and the second arm 112 may be similar in construction and may be symmetrically arranged relative to each other. An engagement region 122 is thus defined in between the first arm 110 and the second arm 112. Further, the first arm 110 may include a first bore 114, while the second arm 112 may include a second bore 116. Both the first bore 114 and the second bore 116 may share a common bore axis 118. In an exemplary embodiment, the roller rocker arm 102 is a cast-iron based structure. The roller rocker arm 102 may be made up of any other material as well, which are commonly known in the art.

At one end 120, the roller rocker arm 102 may include connections that extend to a lifter-pushrod arrangement (not shown). Those extensions may operably engage with affiliated components, such as engine valves, injector plungers, valve bridges, and/or the like.

Further, an auxiliary pin (not shown) may be accommodated within the roller rocker arm 102, which may include a fulcrum axis 124. With such an arrangement, the roller rocker arm 102 may articulate relative to the auxiliary pin, which enables the roller rocker arm 102 to perform a to-and-fro motion, during operation.

The pin 104 may be substantially a cylindrically structured solid device. The pin 104 may be mountable and fixedly secured to the roller rocker arm 102. For that purpose, the pin 104 includes rocker engagement portions 126 that engage with the first arm 110 and the second arm 112 of the roller rocker arm 102. More particularly, the pin 104 is secured to the roller rocker arm 102 by being press-fitted with the first bore 114, the second bore 116, and extending therethrough. In an embodiment, an ensuing arrangement may include a transversal placement of the pin 104, passing through the first arm 110 and the second arm 112. Although not limited, an assembly of the pin 104 to the roller rocker arm 102 may be accomplished by a press-fit connection. Further, a substantial central portion of the pin 104 embodies a race employment portion 128 that may accommodate the inner race assembly 106. In a preferred embodiment, the race employment portion 128 and the rocker engagement portions 126 may possess the same cylindrical diameter. Moreover, the pin 104 includes a center groove 129, which forms an oil passage therein.

The pin 104 may be formed of a known material, for example, carbon steel. As with the roller rocker arm 102, the pin 104 may be a cast-iron based structure, as well. However, other materials, configurations, and manufacturing methods are contemplated.

The inner race assembly 106 may be a hollow cylindrically structured component that complements an accommodation of the pin 104, therein. The inner race assembly 106 may be fixedly mounted about the pin 104. To facilitate such an accommodation, the inner race assembly 106 may include a width that complements the engagement region 122 provided in between and across the first arm 110 and the second arm 112. Moreover, the inner race assembly 106 includes an outer portion referred to as a roller engagement portion 130 that facilitates a rotatable engagement to the roller member 108. The rotatable engagement with the roller member 108 is facilitated by having a layer/cladding made up of a malleable material on the roller engagement portion 130. In an exemplary embodiment, the cladding material is made of bronze or an affiliated alloy. In another embodiment, the inner race assembly 106 may be substantially completely made of bronze or an alloy of bronze. The layer of bronze coating may be of uniform radial thickness and/or varying thickness along the width of the inner race assembly 106.

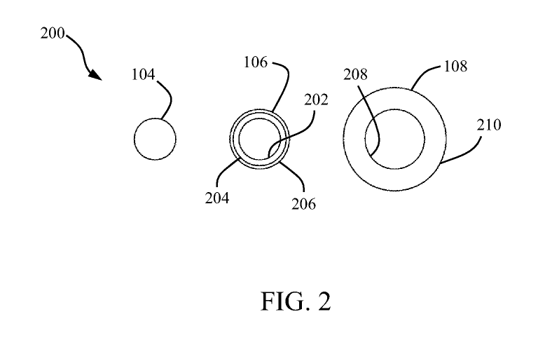

The roller member 108 may be one of the widely applied rollers known in the art, employed within the rocker arm assemblies of internal combustion engines. The roller member 108 may be a hollow cylindrically structured component as well, structured and arranged to be in rotatable engagement with the inner race assembly 106, about the roller engagement portion 130. The roller member 108 may include outer confines that complement and match with the width of the inner race assembly 106. In so doing, the roller member 108 is able to freely rotate with adequate clearance when positioned within the engagement region 122. An outer surface 210 (see FIG. 2) of the roller member 108 may embody a frictional layer that enables the roller member 108 to rotate about a roller axis upon an associated frictional contact.

Referring to FIG. 2, there is shown a component set 200 that includes the pin 104, the inner race assembly 106, and the roller member 108. More particularly, each component within the component set 200 is shown to include a circular profile. Accordingly, the inner race assembly 106 includes a race bore 202, which may facilitate an accommodation of the pin 104 within the inner race assembly 106. More particularly, the race bore 202 engages the race employment portion 128 (see FIG. 1) of the pin 104 during assembly.

For applications that sustain relatively low temperature conditions, the inner race assembly 106 may be formed of a single piece member, perhaps bronze. This is because bronze provides a sliding capability for the roller member 108 to be rotatably engaged to the inner race assembly 106. However, heavy-duty applications that are subject to higher temperatures may require the inner race assembly 106 to incorporate a multi-property piece. Such a multi property piece may include an inner race member 204, formed of carbon-steel, and an outer race member 206, formed of a bronze material. That is because thermal properties of bronze and carbon-steel differ. The outer race member 206 may be fused to the inner race member 204, to define a contiguous and a unitary inner race assembly 106. Alternatively, the outer race member 206 may also be formed of steel, or other similar materials. In addition, other methods of integrating the inner race member 204 and the outer race member 206 may be contemplated. As an example, cladding and/or coating the outer race member 206 with bronze may be envisioned as well. A combination of alternative alloys may be considered too, that may impart a functionality similar to one provided by the outer race member 206. In brevity, the inner race assembly 106 may be a carbon steel tube with bronze cast onto the outer diameter (or the roller engagement portion 130) of the carbon steel tube.

The roller member 108 includes a race engagement portion 208, which rotatably engages to the roller engagement portion 130 of the inner race assembly 106. The race engagement portion 208 may be cylindrically shaped to comply with the roller engagement portion 130.

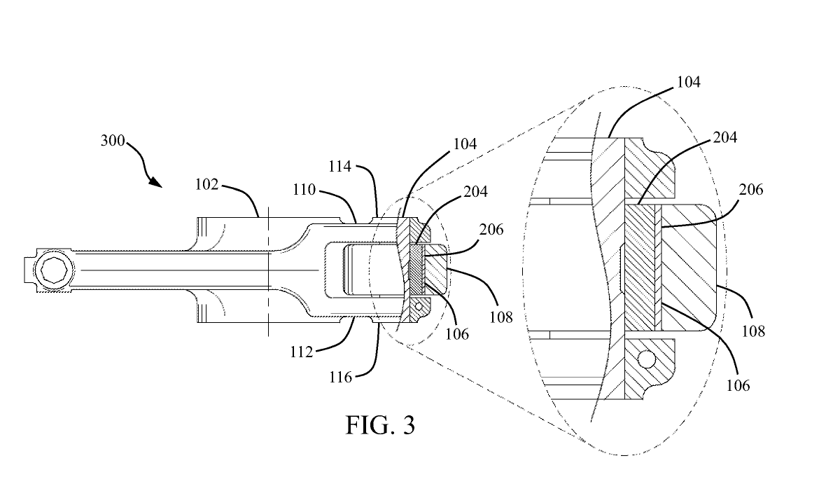

Referring to FIG. 3, there is shown an assembled unit 300 of the roller assembly 100. When in assembly, the component set 200 shares a common axis of rotation, which is the bore axis 118. As the pin 104 is generally press-fitted to the roller rocker arm 102, in a similar fashion, the inner race assembly 106 may be in fixed engagement with the pin 104. However, the inner race assembly 106 may be positioned in press fit with the race engagement portion 208 of the roller member 108. Accordingly, the roller member 108 is configured to freely rotate relative to the roller rocker arm 102. Further, a common axis between the pin 104, the inner race assembly 106, and the roller member 108, is aligned to the bore axis 118.

### INDUSTRIAL APPLICABILITY

In operation, the race engagement portion 208 of the roller member 108 rotatably slips relative to the roller engagement portion 130 of the inner race assembly 106. Over time, dirt or oil may be deposited on the outer race member 206 of the inner race assembly 106. The bronze coating/layer of outer race member 206 and race engagement portion 208 provides a rotational slip, even in considerably adverse conditions of engine operation, specified above. That arrangement enables the roller member 108 to freely rotate about the bore axis 118. Notably, the present disclosure avoids the use of a bushing between the roller member 108 and the inner race assembly 106. With such an arrangement, the inner race assembly 106 includes an outer diameter that matches with the diameter of conventionally applied bushings within rollers, such as the roller member 108.

Moreover, the present disclosure proposes the use of the inner race assembly 106 as a retrofit option to conventionally applied rocker arms. Such a configuration also allows for a large bearing surface (roller engagement portion 130) with reduced stresses on the first arm 110 and the second arms 112. Additionally, the roller rocker arm 102 has relatively less material on the inner race assembly 106 as compared to conventional applications. Further, minimizing components in such an assembly, while upholding affiliated functions, imparts enhanced functional reliability to the associated operation.

It should be understood that the above description is intended for illustrative purposes only and is not intended to limit the scope of the present disclosure in any way. Thus, those skilled in the art will appreciate that other aspects of the disclosure may be obtained from a study of the drawings, the disclosure, and the appended claim.

What is claimed is:

1. A roller assembly for application to a roller rocker arm, the roller assembly comprising:
a pin mountable to the roller rocker arm, the pin consisting of a carbon steel;
an inner race assembly operably connectable to the pin, the inner race assembly comprising:
an inner race member and an outer race member, the inner race member being comprised of carbon steel and the outer race member being comprised of a bronze material, said outer race member being fused to the inner race member to define a contiguous and unitary inner race assembly; and
a roller member structured and arranged to be in rotatable engagement with the inner race assembly.
